(19) United States
(12) Patent Application Publication
(10) Pub. No.: US 2026/0039010 A1
(43) Pub. Date: Feb. 5, 2026

(54) RADIATING ELEMENTS FOR MULTIBAND BASE STATION ANTENNAS HAVING CAVITY PHASE SHIFTERS AND RELATED LINEAR ARRAY ASSEMBLIES AND BASE STATION ANTENNAS

(71) Applicant: Outdoor Wireless Networks LLC, Richardson, TX (US)

(72) Inventors: Cheng Xue, Suzhou (CN); Changfu Chen, Suzhou (CN); Jian Zhang, Suzhou (CN); Bin Sun, Suzhou (CN); Pengfei Guo, Suzhou (CN); YueMin Li, Suzhou (CN)

(21) Appl. No.: 19/270,641

(22) Filed: Jul. 16, 2025

(30) Foreign Application Priority Data
Jul. 30, 2024 (CN) 2024110367843

(51) Int. Cl. H01Q 1/24; H01Q 1/52; H01Q 3/36; H01Q 9/04

(52) U.S. Cl. CPC H01Q 1/246; H01Q 1/523; H01Q 3/36; H01Q 9/0407

(57) ABSTRACT

A radiating element for a base station antenna comprises a feed stalk printed circuit board, a coupling printed circuit board mounted on a distal end of the feed stalk printed circuit board, the coupling printed circuit board including a plurality of metal pads, and a metal radiator that is capacitively coupled to the coupling printed circuit board and that forms at least part of a first radiator and a second radiator, the metal radiator comprising a monolithic metal plate that includes at least one opening.

### CROSS-REFERENCE TO RELATED APPLICATION

The present application claims priority to Chinese Patent Application Serial No. 202411036784.3, filed Jul. 30, 2024, the entire content of which is incorporated herein by reference.

### FIELD

The present disclosure relates to communications systems and, in particular, to base station antennas for cellular communications systems.

### BACKGROUND

Cellular communications systems are well known in the art. In a cellular communications system, a geographic area is divided into a series of regions that are referred to as “cells” which are served by respective base stations. Each base station may include one or more base station antennas that are configured to provide two-way radio frequency (“RF”) communications with mobile subscribers that are within the cell served by the base station. Typically, the base station antennas are mounted on a tower or other raised structure, with the radiation patterns (also referred to herein as “antenna beams”) that are generated by the base station antennas directed outwardly.

A common base station configuration is the three sector configuration in which a cell is divided into three 120° “sectors” in the azimuth (horizontal) plane. A separate base station antenna provides coverage (service) to each sector. Typically, each base station antenna will include multiple vertically-extending columns of radiating elements that operate, for example, using second generation (“2G”), third generation (“3G”) or fourth generation (“4G”) cellular network protocols. These vertically-extending columns of radiating elements are typically referred to as “linear arrays.” and may be straight columns of radiating elements or columns in which some of the radiating elements are staggered horizontally to narrow the beamwidths of the generated antenna beams in the azimuth (horizontal) plane. Most modern base station antennas include both “low-band” linear arrays of radiating elements that support service in some or all of the 617-960 MHz frequency band and “mid-band” linear arrays of radiating elements that support service in some or all of the 1427-2690 MHz frequency band. These linear arrays are typically formed using dual-polarized radiating elements, which allows each linear array to be connected to a pair of radios (or radio ports of a single radio) so that the linear array can transmit and receive RF signals at two orthogonal polarizations (i.e., an antenna beam is generated at each orthogonal polarization).

Each of the above-described linear arrays of dual-polarized radiating elements is coupled to two ports of a radio (one port for each polarization). An RF signal that is to be transmitted by one of the linear arrays is passed from the radio to the antenna where it is divided into a plurality of sub-components, with each sub-component fed to a respective subset of the radiating elements in the linear array (typically each sub-component is fed to between one and three radiating elements). The sub-components of the RF signal are transmitted through the radiating elements to generate an antenna beam that covers a generally fixed coverage area, such as a 120° sector of a cell. Typically these linear arrays will have remote electronic tilt (“RET”) capabilities which allow a cellular operator to change, from a control center, the pointing angle of the generated antenna beams in the elevation (vertical) plane in order to change the size of the sector served by the linear array (since the more that the antenna beam is downtilted in the elevation plane, the smaller the area that is illuminated by the antenna beam, and hence the smaller the size of the area covered by the antenna beam). Since the antenna beams generated by the above-described 2G/3G/4G linear arrays are static antenna beams that only change in shape due to adjustments in the downtilt angle of the antenna beam, they are often referred to as “passive” linear arrays.

Cellular operators are currently upgrading their networks to support fifth generation (“5G”) cellular service. One important component of 5G cellular service is the use of multi-column “active” beamforming arrays that operate in conjunction with beamforming radios. The beamforming radios change the amplitudes and/or phases of the sub-components of a signal that is to be transmitted. The sub-components of the signal are passed to respective subsets of the radiating elements of the active beamforming array in order to dynamically adjust the size, shape and pointing direction of the antenna beams that are generated by the active beamforming array. These active beamforming arrays are typically formed using “high-band” radiating elements that operate in higher frequency bands, such as some or all of the 3.3-4.2 GHz frequency bands, although active beamforming radios may also be provided that operate in other frequency bands such as the upper portion (e.g., 2.5-2.7 GHz) of the mid-band frequency range. The radiating elements in each vertically-extending column of such an active beamforming array are typically coupled to a respective port of a beamforming radio so that each column of radiating elements is fed a different sub-component of the signal to be transmitted. The beamforming radio may be a separate device, or may be integrated with the active antenna array. As discussed above, the beamforming radio may adjust the amplitudes and phases of the sub-components of an RF signal that are fed to each port of the radio (and hence to each respective column of radiating elements in the multi-column beamforming array) in order to generate antenna beams that have narrowed beamwidths in the azimuth plane (and hence higher antenna gain). These narrowed antenna beams can be electronically steered throughout the sector by proper selection of the amplitudes and phases of the sub-components of the RF signal. In order to avoid having to increase the number of antennas at cell sites, 5G antennas that include such beamforming arrays also often include passive linear arrays that support legacy 2G, 3G and/or 4G cellular services.

### SUMMARY

Pursuant to some embodiments of the present invention, radiating elements for a base station antenna are provided that comprise a feed stalk printed circuit board, a coupling printed circuit board mounted on a distal end of the feed stalk printed circuit board, the coupling printed circuit board including a plurality of metal pads, and a metal radiator that is capacitively coupled to the coupling printed circuit board and that forms at least part of a first radiator and a second radiator, the metal radiator comprising a monolithic metal plate that includes at least one opening.

In some embodiments, the at least one opening comprises a first slot-like opening that has a first longitudinal axis that extends in a first direction and a second slot-like opening that has a second longitudinal axis that extends in a second direction that is perpendicular to the first direction. In some embodiments, the metal radiator further includes a plurality of triangular-shapedopenings. In some embodiments, the first slot-like opening extends from a first corner of a first of the triangular-shaped openings and the second slot-like opening extends from a second corner of the first of the triangular-shaped openings.

In some embodiments, the metal radiator includes an outer perimeter and the at least one opening comprises a first plurality of openings that together form a discontinuous central opening that is surrounded by the outer perimeter, and a plurality of slot-like openings extend outwardly from the central opening. In some embodiments, the metal radiator further includes a first metal strip that extends through the central opening and a second metal strip that extends through the central opening, where the second metal strip intersects the first metal strip. In some embodiments, a first of the slot-like openings extends in parallel to the first metal strip and a second of the slot-like openings extends in parallel to the second metal strip.

In some embodiments, an amount of capacitive coupling between the coupling printed circuit board and the metal radiator is selected so that common mode currents that are within the 696-960 MHz frequency range are substantially blocked from coupling from the coupling printed circuit board to the metal radiator.

In some embodiments, the feed stalk printed circuit board is electrically coupled to both the first radiator and the second radiator.

In some embodiments, the metal radiator comprises a sheet metal radiator plate. In some embodiments, the metal radiator includes a planar main section and a plurality of distal extensions that are bent with respect to the planar main section.

In some embodiments, the radiating element may further comprise a base board printed circuit board that includes a slot therethrough, and a base of the feed stalk printed circuit board is inserted through the slot in the base board printed circuit board. In some embodiments, a rear side of the base board printed circuit board includes a metal pad, and a plurality of ground traces on the feed stalk printed circuit board are soldered to the metal pad.

In some embodiments, the radiating element may be provided in combination with a cavity phase shifter assembly that comprises a metal shell having first and second cavities, a first phase shifter within the first cavity, and a second phase shifter within the second cavity. In these embodiments, the metal pad on the base board printed circuit board may, for example, be mounted to capacitively couple with the metal shell. In some embodiments, the first phase shifter comprises a first phase shifter printed circuit board and the second phase shifter comprises a second phase shifter printed circuit board, and wherein the feed stalk printed circuit board is mounted on the first and second phase shifter printed circuit boards. In some embodiments, the feed stalk printed circuit board may be mounted perpendicular to the first and second phase shifter printed circuit boards. In some embodiments, a first solder joint may electrically connect a first signal trace on the first phase shifter printed circuit board to a first signal trace on the feed stalk printed circuit board, and a second solder joint may electrically connect a second signal trace on the second phase shifter printed circuit board to a second signal trace on the feed stalk printed circuit board.

In some embodiments, a front wall of the metal shell may include first and second openings, and first and second rearwardly extending tabs on the feed stalk printed circuit board may extend through the respective first and second openings. In some embodiments, a side wall of the metal shell may include a window that is aligned with the first opening in the front wall of the metal shell.

In some embodiments, the radiating element and the cavity phase shifter assembly may be part of a base station antenna, where the base station antenna includes a reflector that has an opening that is larger than a footprint of the coupling printed circuit board, and where the radiating element is mounted to extend through the opening in the reflector. In some embodiments, the first and second phase shifter printed circuit boards may be mounted rearwardly of the reflector. In some embodiments, a footprint of the metal radiator may be larger than the footprint of the opening in the reflector.

Pursuant to further embodiments of the present invention, a radiating element for a base station antenna is provide that comprises a base board printed circuit board that comprises a dielectric substrate and a metal pattern on a first surface of the dielectric substrate, the base board printed circuit board including a slot that extends through the dielectric substrate and the metal pattern, a feed stalk printed circuit board that has a base that is inserted through the slot in the base board printed circuit board and a distal end, a coupling printed circuit board mounted on the distal end of the feed stalk printed circuit board, and a metal radiator that is capacitively coupled to the coupling printed circuit board. The feed stalk printed circuit includes first and second pairs of ground traces that are galvanically connected to the metal pattern on the base board printed circuit board, and first and second signal traces that are electrically isolated from the base board printed circuit board.

In some embodiments, the metal radiator forms at least part of a first radiator and a second radiator, the metal radiator comprising a monolithic metal plate that includes at least one opening. In some embodiments, the at least one opening comprises a first slot-like opening that has a first longitudinal axis that extends in a first direction and a second slot-like opening that has a second longitudinal axis that extends in a second direction that is perpendicular to the first direction. In some embodiments, the metal radiator further includes a plurality of triangular-shaped openings. In some embodiments, the first slot-like opening extends from a first corner of a first of the triangular-shaped openings and the second slot-like opening extends from a second corner of the first of the triangular-shaped openings.

In some embodiments, the metal radiator includes an outer perimeter and the at least one opening comprises a first plurality of openings that together form a discontinuous central opening that is surrounded by the outer perimeter, and a plurality of slot-like openings extend outwardly from the central opening. In some embodiments, the metal radiator further includes a first metal strip that extends through the central opening and a second metal strip that extends through the central opening, where the second metal strip intersects the first metal strip. In some embodiments, a first of the slot-like openings extends in parallel to the first metal strip and a second of the slot-like openings extends in parallel to the second metal strip.

In some embodiments, the feed stalk printed circuit board is electrically coupled to both the first radiator and the second radiator.

In some embodiments, the metal radiator comprises a sheet metal radiator plate.

In some embodiments, the base board printed circuit board includes a slot therethrough and the base of the feed stalk printed circuit board is inserted through the slot in the base board printed circuit board.

In some embodiments, the radiating element is provided in combination with a cavity phase shifter assembly that comprises a metal shell having first and second cavities, a first phase shifter within the first cavity, and a second phase shifter within the second cavity. The metal pad on the base board printed circuit board is mounted to capacitively couple with the metal shell. In some embodiments, the first phase shifter comprises a first phase shifter printed circuit board and the second phase shifter comprises a second phase shifter printed circuit board, and wherein the feed stalk printed circuit board is mounted on the first and second phase shifter printed circuit boards. In some embodiments, a first solder joint electrically connects a first signal trace on the first phase shifter printed circuit board to a first signal trace on the feed stalk printed circuit board, and a second solder joint electrically connects a second signal trace on the second phase shifter printed circuit board to a second signal trace on the feed stalk printed circuit board. In some embodiments, a front wall of the metal shell includes first and second openings, and first and second rearwardly extending tabs on the feed stalk printed circuit board extend through the respective first and second openings.

Pursuant to still further embodiments of the present invention, base station antennas are provided that comprise a reflector, a first array of lower frequency band radiating elements, and a second array of higher frequency band radiating elements. At least some of the higher frequency band radiating elements comprise a feed stalk, a coupling printed circuit board mounted on the feed stalk, and a metal radiator that is capacitively coupled to the coupling printed circuit board. An amount of capacitive coupling between the coupling printed circuit board and the metal radiator is selected so that common mode currents that are within an operating frequency range of the lower frequency band radiating elements are substantially blocked from coupling from the coupling printed circuit board to the metal radiator.

In some embodiments, the reflector includes a plurality of openings and the at least some of the higher frequency band radiating elements extend through the respective openings in the reflector. In some embodiments, each of the plurality of openings is larger than footprints of the coupling printed circuit boards of the at least some of the higher frequency band radiating elements.

In some embodiments, the metal radiator comprises a monolithic metal plate that has an outer perimeter and a plurality of openings that are surrounded by the outer perimeter. In some embodiments, the metal radiator further includes a first metal strip that extends through the plurality of openings and a second metal strip that extends through the plurality of openings, where the second metal strip intersects the first metal strip.

### BRIEF DESCRIPTION OF THE DRAWINGS

FIG. 1A is a front perspective view of a conventional base station antenna that includes both passive 2G/3G/4G linear arrays and an active beamforming array.

FIG. 1B is a schematic front view of the conventional base station antenna of FIG. 1A with the radome removed.

FIG. 2A is a schematic front view of a base station antenna according to embodiments of the present invention with the radome removed.

FIG. 2B is a schematic front perspective view of four mid-band linear array assemblies of the base station antenna of FIG. 2A, with a main reflector of the base station antenna shown for context.

FIG. 3 is a schematic side perspective view of one of the mid-band radiating elements included in the mid-band linear array assemblies of FIG. 2.

FIGS. 4A and 4B are plan views of the first and second major surfaces of the feed stalk printed circuit board included in the mid-band radiating element of FIG. 3.

FIG. 5 is a schematic side view of the mid-band radiating element of FIG. 3.

FIG. 6 is a schematic rear perspective view of the mid-band radiating element of FIG. 3.

FIG. 7 is a schematic side view of the mid-band radiating element of FIG. 3 illustrating the common mode current path for low-band common mode currents.

FIG. 8 is a graph illustrating the magnitude of the common mode currents on the mid-band radiating element of FIG. 3 and on a conventional radiating element as a function of frequency.

FIG. 9A is a schematic front perspective view of one of the mid-band linear array assemblies of FIG. 2.

FIG. 9B is a schematic end view of the cavity phase shifter assembly of the mid-band linear array assembly of FIG. 9A.

FIG. 10 is an exploded side perspective view illustrating how the mid-band radiating element of FIGS. 3-7 is mounted on a cavity phase shifter assembly of the mid-band linear array assembly of FIG. 9A.

FIG. 11 is the same view as FIG. 10 with the metal shell of the cavity phase shifter assembly and a base board printed circuit board of the mid-band radiating element omitted to show how a feed stalk printed circuit board of the mid-band radiating element is mounted on a pair of phase shifter printed circuit boards of the cavity phase shifter assembly.

FIG. 12 is a schematic exploded from perspective view of the four mid-band linear array assemblies of FIG. 2.

FIGS. 13A and 13B are plan views of two metal radiators that can be used with the mid-band radiating elements according to embodiments of the present invention that illustrate the current paths thereon.

FIGS. 14A-14F are plan views of metal radiator plates that may be used to implement the mid-band radiating elements according to embodiments of the present invention.

It should be noted that herein reference numerals that include two numbers separated by a dash may be used, and that like elements may be referred to individually by their full reference numeral and may be referred to collectively by the first part of their reference numeral.

### DETAILED DESCRIPTION

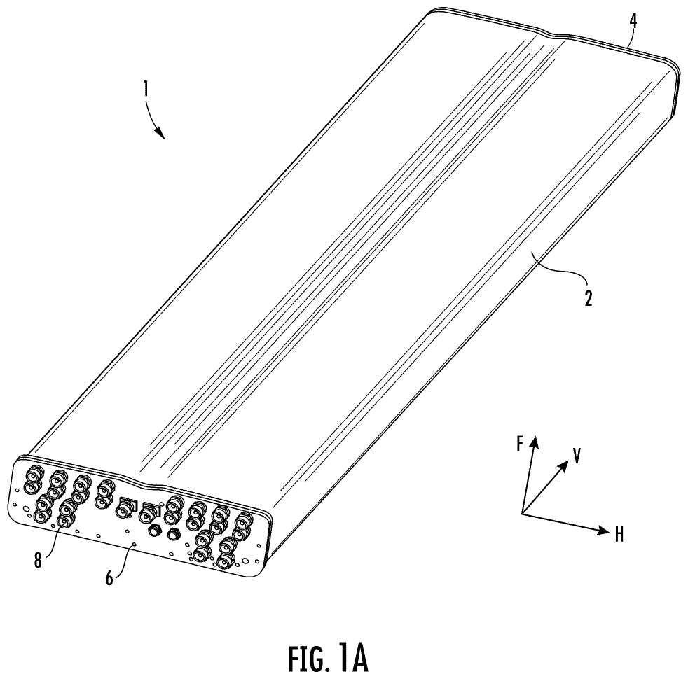

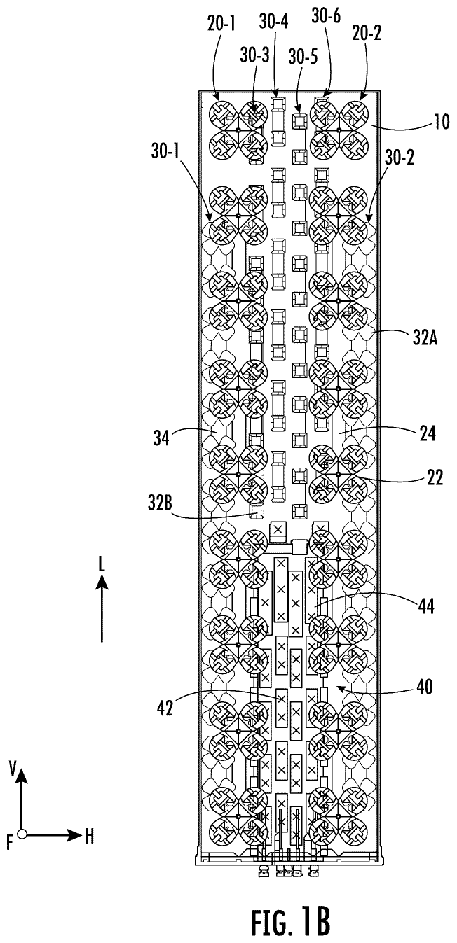

FIGS. 1A and 1B illustrate a conventional base station antenna 1 that includes both passive low-band and mid-band linear arrays and a high-band active beamforming array. In particular, FIG. 1A is a front perspective view of the base station antenna 1, and FIG. 1B is a schematic front view of the base station antenna 1 with the radome thereof removed. In FIGS. 1A and 1B, the axes illustrate the vertical (V), horizontal (H) and forward (F) directions of the base station antenna system 1. In the description that follows, each antenna will be described using terms that assume that the antenna is mounted for use on a tower with the longitudinal axis L of the antenna extending along the vertical axis V and the front surface of the antenna mounted opposite the tower pointing toward the coverage area for the antenna.

Referring to FIG. 1A, the base station antenna 1 has a tubular shape with a generally rectangular cross-section. The base station antenna 1 includes a radome 2 a top end cap 4 and a bottom end cap 6. One or more mounting brackets (not shown) may be provided on the rear side of the antenna 1 which may be used to mount the antenna 1 onto an antenna mount (not shown) on, for example, an antenna tower. A plurality of RF ports 8 in the form of RF connectors are mounted in the bottom end cap 6. The RF ports 8 extend through the bottom end cap 6 and are used to electrically connect the base station antenna 1 to external radios (not shown). The radome 2, top end cap 4 and bottom cap 6 may form an external housing for the antenna 1. An antenna assembly (FIG. 1B) is contained within the housing.

FIG. 1B is a schematic front view of the antenna assembly that is contained within the housing of base station antenna 1. As shown in FIG. 1B, the antenna assembly includes a reflector 10. The reflector 10 may serve as both a structural component for the antenna assembly and as a ground plane and reflector for at least some of the radiating elements (discussed below) of antenna 1. The reflector 10 includes a generally flat metallic surface that extends in the longitudinal direction L of the antenna 1. Various mechanical and electronic components of base station antenna 1 (not shown) are mounted behind the reflector 10.

The antenna assembly further includes first and second low-band arrays 20-1, 20-2 of low-band radiating elements 22, first and second mid-band arrays 30-1, 30-2 of first mid-band radiating elements 32A, third through sixth mid-band arrays 30-3 through 30-6 of second mid-band radiating elements 32B, and a multi-column high-band array 40 of high-band radiating elements 42. The low-band arrays 20 and mid-band arrays 30 are each implemented as vertically-extending linear arrays of radiating elements. The low-band and mid-band linear arrays 20, 30 may support, for example, 2G, 3G and/or 4G cellular service. Each of the low-band and mid-band linear arrays 20, 30 are passive arrays that generate static antenna beams that provide coverage to a predefined coverage area (e.g., antenna beams that are each configured to cover a 120° sector of a base station), with the only change to the coverage area occurring when the electronic downtilt angles of the generated antenna beams are adjusted (e.g., to change the size of the cell).

The high-band radiating elements 42 are mounted in four columns in the lower center portion of the reflector 10 to form the multi-column array 40. Each column of the multi-column array 40 may be coupled to a pair of ports (one for each polarization) of a beamforming radio so that the multi-column array 40 operates as an active beamforming array that generates narrowed antenna beams that can be steered in the azimuth plane throughout the coverage area.

The low-band radiating elements 22 are configured to transmit and receive signals in the 617-960 MHz frequency range or a portion thereof (e.g., the 617-896 MHz frequency band, the 696-960 MHz frequency band, etc.). The first mid-band radiating elements 32A are configured to transmit and receive signals in the 1427-2690 MHz frequency range or a portion thereof (e.g., the 1427-1710 MHz frequency band, the 1427-2200 MHz frequency band, etc.). The second mid-band radiating elements 32B are configured to transmit and receive signals in the 1695-2690 MHz frequency range or a portion thereof (e.g., the 1710-2200 MHz frequency band, the 2300-2690 MHz frequency band, etc.). The second mid-band radiating elements 32B may have a different design than the first mid-band radiating elements 32A. The high-band radiating elements 42 are configured to transmit and receive signals in the 3300-4200 MHz frequency range or a portion thereof. The radiating elements 22, 32A, 32B, 42 are mounted to extend forwardly from the reflector 10.

The low-band and mid-band radiating elements 22, 32A, 32B may each be implemented as dual-polarized radiating elements that each include first and second radiators that are configured to transmit and receive RF energy at orthogonal polarizations. For example, the low-band and mid-band radiating elements 22, 32A, 32B may be implemented as slant −45°/+45° cross-dipole radiating element that include a −45° dipole radiator and a +45° dipole radiator that are arranged to form a cross when the radiating elements 22, 32A, 32B are viewed from the front. The dipole radiators of each low-band and mid-band radiating element 22, 32A, 32B are mounted on a feed stalk (not visible in the figures) that passes RF signals between the dipole radiators and an associated feed network.

Since dual-polarized radiating elements are used, each of the low-band and mid-band linear arrays 20, 30 is connected to a pair of the RF ports 8. The first RF port 8 of each pair is connected to a first port of a passive (non-beamforming) radio (e.g., a remote radio head mounted on the antenna tower near the base station antenna 1), typically by a coaxial cable. A feed cable and a feed network connect the first RF port 8 to the first polarization radiators of the radiating elements 22, 32A, 32B in the respective linear arrays 20, 30. Similarly, the second RF port 8 of each pair is connected to a second port of the radio by a coaxial cable, and another feed cable and feed network connect the second RF port 8 to the second polarization radiators of the radiating elements 22, 32A, 32B in a respective one of the linear arrays 20, 30. RF signals that are to be transmitted by a selected one of the low-band and mid-band linear arrays 20, 30 are passed from the associated radio to one of the RF ports 8, and passed from the RF port 8 to the associated feed network. Each feed network may include a phase shifter assembly that includes a power divider that divides the RF signal into a plurality of sub-components that are fed to the respective first or second radiators of the radiating elements 22, 32A, 32B in the linear array 20, 30 so that the sub-components are radiated into free space. Accordingly, each linear array 20, 30 may be used to form a pair of antenna beams, namely an antenna beam for each of the two polarizations at which the dual-polarized radiating elements included in the respective array are designed to transmit and receive RF signals. Each linear array 20, 30 may be configured to provide service to a sector of a base station. For example, each linear array 20, 30 may be configured to provide coverage to approximately 120° in the azimuth plane so that the base station antenna 1 may act as a sector antenna for a three-sector base station.

The high-band radiating elements 42 are also implemented as dual polarized slant −45°/+45° cross-dipole radiating elements. Each column of high-band radiating elements 42 is coupled to a pair of ports (one port for each polarization) of a beamforming radio (not shown) that may be, for example, mounted on the antenna tower adjacent the antenna 1. The beamforming radio is capable of electronically adjusting the amplitudes and/or phases of the subcomponents of an RF signal that are output to each column of high-band radiating elements 42 of the multi-column beamforming array 40. The beamforming radio may change the size, shape and pointing direction of the generated antenna beams by adjusting the amplitudes and/or phases of the subcomponents of an RF signal that are output to each column. These adjustments may be made, for example, on a time slot by time slot basis of a time division multiple access scheme.

As shown best in FIG. 1B, the low-band radiating elements 22 may be mounted on low-band feed board printed circuit boards 24, the mid-band radiating elements 32A, 32B may be mounted on mid-band feed board printed circuit boards 34, and the high-band radiating elements 42 may be mounted on high-band feed board printed circuit boards 44. The feed board printed circuit boards 24, 34, 44 couple RF signals between groups of one to three radiating elements 22, 32A, 32B, 42 and phase shifter assemblies that are interposed between the RF ports 8 and the arrays 20, 30, 40. Cables (not shown) may be used to connect each feed board printed circuit board 24, 34, 44 to the phase shifter assemblies.

While the conventional base station antenna 1 of FIGS. 1A-1B can support a wide range of communications services, in practice it can be difficult to manufacture. Cellular operators tend to have strict limitations on the acceptable physical sizes for various types of base station antennas, since the base station antennas are often mounted on tall antenna towers where they can be subject to very high wind loads. As the size of a base station antenna increases, wind-loading considerations can greatly increase the structural requirements for the antenna mounting hardware and the antenna tower, which can significantly increase the cost of implementing a base station. Thus cellular operators often place strict limits on the lengths, widths and/or depths of each type of base station antenna.

Multiband base station antennas that support cellular service in all three of the low-band, mid-band and high-band frequency ranges typically include at least eight columns of radiating elements, and often as many as twelve, sixteen or more columns of radiating elements. Because of the size constraints for the antenna, radiating elements that operate in different frequency bands are often in very close proximity within the antenna, which may cause the radiating elements from adjacent arrays to interact with each other, typically in undesirable ways. In addition, the number of feed networks included in the base station antennas increases linearly with the number of arrays of radiating elements. These feed networks are typically mounted behind the linear arrays, and the cables, phase shifters and other elements of the various feed networks are often intertwined. Each base station antenna is typically tested after the antenna is assembled to identify problems such as unintended passive intermodulation (“PIM”) distortion sources (such as poorly formed solder joints or loose metal-to-metal connections that can generate unwanted RF noise), faulty connections, inoperable components (e.g., phase shifters, RET units, etc.) and the like. When such problems are identified, it often is difficult to identify the source of the problem, let alone fix the problem, within the assembled antenna since it is difficult to access many of the components of the antenna (and in particular components that are behind the main reflector) due to the crowded design. As a result, when problems are identified, the base station antenna system often must be partly or completely disassembled to identify and fix the problems. This can greatly increase production costs.

Another problem with current multiband base station antennas is that the RF paths to radiating elements of at least some of the low-band, mid-band and high-band arrays may cross back and forth between the front and back sides of the main reflector. As a result, the RF performance of these arrays cannot be tested until the base station antenna is assembled. If problems are identified, the antenna then typically has to be disassembled to fix the problems.

Pursuant to embodiments of the present invention, multi-band base station antennas are provided that have low-cost, high performance radiating elements that have low interaction on arrays operating in other frequency bands. In the embodiments discussed below, these radiating elements are mid-band radiating elements, but it will be appreciated that the techniques disclosed herein may be used to form radiating elements that operate in other frequency bands. The radiating elements according to embodiments of the present invention may have a feed stalk that comprises a single printed circuit board, which reduces cost and which may also reduce the impact that the mid-band radiating elements have on nearby radiating elements that operate in other frequency bands. The radiating elements according to embodiments of the present invention may further include a small coupling printed circuit board that is mounted on a distal end of the feed stalk printed circuit board, and a metal radiator that includes a plurality of slots that is mounted on and capacitively coupled to the coupling printed circuit board. The radiating element may further include a base board printed circuit board that mechanically supports the feed stalk printed circuit board and that may also be used to electrically connect the feed stalk printed circuit board to a ground reference.

In some embodiments, the base station antenna may include “wireless” cavity phase shifter assemblies for at least some of the mid-band linear arrays. “Wireless” phase shifter assemblies refer to phase shifter assemblies that have outputs that connect directly to the radiating elements of the array (or to feed board printed circuit boards for the radiating elements), thereby eliminating the need for coaxial “phase cables” that extend from the outputs of a conventional phase shifter assembly to the radiating elements (or feed board printed circuit boards) of the array. Each cavity phase shifter assembly includes a phase shifter that is mounted within a grounded metal shell so that the RF transmission lines of the phase shifter operate as low-loss stripline transmission lines.

The cavity phase shifter assemblies may be mounted behind a reflector of the base station antenna. The mid-band radiating elements according to embodiments of the present invention may be partially pre-assembled, with the feed stalk printed circuit board mounted on the base board printed circuit board, and the small coupling printed circuit board mounted on the feed stalk printed circuit board. This simplifies the manufacturing response, since the mid-band linear arrays with their associated feed networks may be mostly assembled before they are installed into the base station antenna. In addition, prior to being mounted in the base station antenna, the metal radiators may be removably mounted on the respective coupling printed circuit boards so that the mid-band linear arrays and their associated feed networks may be pre-tested so that any defects may be identified and corrected before the cavity phase shifters and partially assembled radiating elements are mounted in the base station antenna.

The main reflector of the base station antenna may include a plurality of openings at the positions where the mid-band radiating elements are to be mounted. These openings may be slightly larger than the footprints of the base board printed circuit board and/or the coupling printed circuit board so that the coupling printed circuit board, the feed stalk printed circuit board and (optionally) the base board printed circuit board of each radiating element may be inserted through a respective one of the openings in the reflector when the cavity phase shifter assembly is mounted in the base station antenna. The metal radiators may then be mounted on the coupling printed circuit boards (e.g., using a plastic support) to complete the manufacture of the mid-band linear array. This process simplifies the manufacture of the base station antenna, and allows the base station antenna to include a common main reflector that serves as the ground plane for multiple linear arrays, which may improve performance.

One difficulty with multiband antennas is that RF radiation transmitted and received by a lower frequency band radiating element may generate common mode currents on a nearby higher frequency band radiating element, particularly in cases where the feed stalk and dipole arm of the higher frequency band radiating element have a combined length that is close to a quarter wavelength of the frequency of the lower frequency band RF radiation. Unfortunately, the mid-band operating frequency range encompasses frequencies that are about twice frequencies in the upper portion of the low-band operating frequency range. As such, the electrical length of the combination of the feed stalk and a dipole arm of most mid-band radiating elements is about 0.25-0.35 wavelengths corresponding to frequencies in the upper portion of the low-band operating frequency range. Consequently, non-trivial common mode currents may be induced on the mid-band radiating elements when excited by RF energy in the low-band operating frequency range. The inducement of these common mode currents on the higher frequency band radiating element is referred to as a common mode resonance. These common mode resonances may distort the radiation patterns of the lower frequency band linear arrays.

The combined length of the feed stalk printed circuit board and a metal pad on the coupling printed circuit board may be designed to be, for example, less than 0.3 wavelengths of the wavelength corresponding to the lowest frequency of the mid-band operating frequency range (where the lowest frequency is typically either 1427 MHz or 1695 MHz). This ensures that the combined length of the feed stalk printed circuit board and the metal pad on the coupling printed circuit board is substantially less than a quarter wavelength of any frequency in the low-band operating frequency range, thereby ensuring that a common mode resonance of the mid-band radiating elements is not within the operating frequency band of the low-band radiating elements. The metal radiator is capacitively coupled to the coupling printed circuit board, and in combination with the pads on the coupling printed circuit board provides radiators that are resonant in the mid-band operating frequency range. The amount of capacitive coupling between the coupling printed circuit board and the metal radiator may be controlled so that lower frequency common mode currents cannot readily couple across the gap between the coupling printed circuit board and the metal radiator. As such, the metal radiator is isolated from the common mode current path, ensuring that the common mode resonance is outside the low-band operating frequency range. The amount of capacitance, however, may be high enough such that the metal radiator has a good impedance match to the coupling printed circuit board, ensuring that the mid-band radiating element provides good return loss performance over the entire mid-band operating frequency range. The amount of capacitive coupling may be controlled by controlling the size, shape and positions of the metal pads on the coupling printed circuit board and the slots in the metal radiator.

The base station antenna may include a main reflector that is mounted directly in front of the cavity phase shifter assemblies. The main reflector may act as a ground plane for the mid-band radiating elements and may redirect forwardly RF radiation that is emitted rearwardly by the mid-band radiating elements. The reflector may include a respective opening at the locations where the mid-band radiating elements are to be mounted. The base board printed circuit board and the coupling printed circuit board of each mid-band radiating element may be sized so that they may fit through these openings. This allows the mid-band radiating elements to be partially pre-assembled (i.e., the base board printed circuit board, the feed stalk printed circuit board and the coupling printed circuit board of each radiating element may be assembled together) and soldered in place on the cavity phase shifter assemblies before the cavity phase shifter assemblies are installed within the base station antenna, which simplifies the manufacturing process. In addition, the metal radiator and the director of each mid-band radiating element may be removably mounted on the coupling printed circuit boards so that the mid-band linear array assemblies may be tested before they are installed in the antenna. As a result, poor solder joints, improper connections and other manufacturing issues can be identified and corrected before the antenna is assembled. After testing, the metal radiators and the directors may be removed so that the cavity phase shifter assemblies may be mounted in the base station antenna with the partially assembled mid-band radiating elements extending through the openings in the main reflector. The metal radiators and the directors may then be reinstalled on the partially assembled mid-band radiating elements in front of the main reflector to complete the fabrication of the mid-band linear array assemblies.

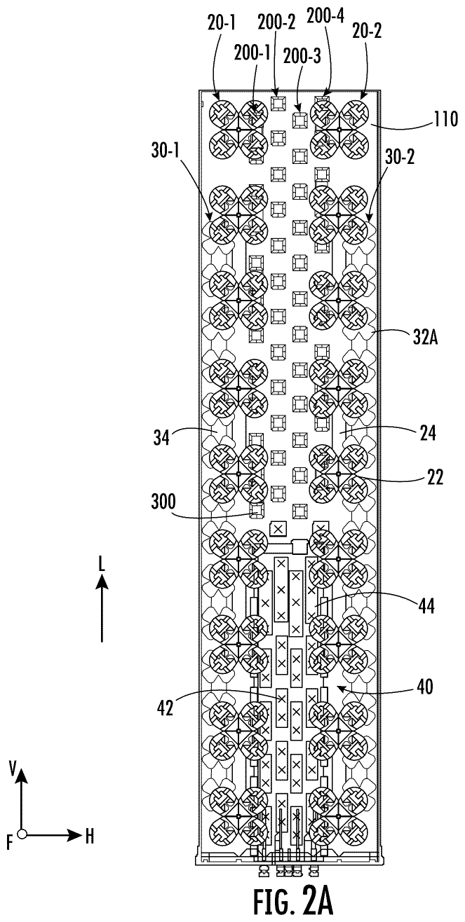

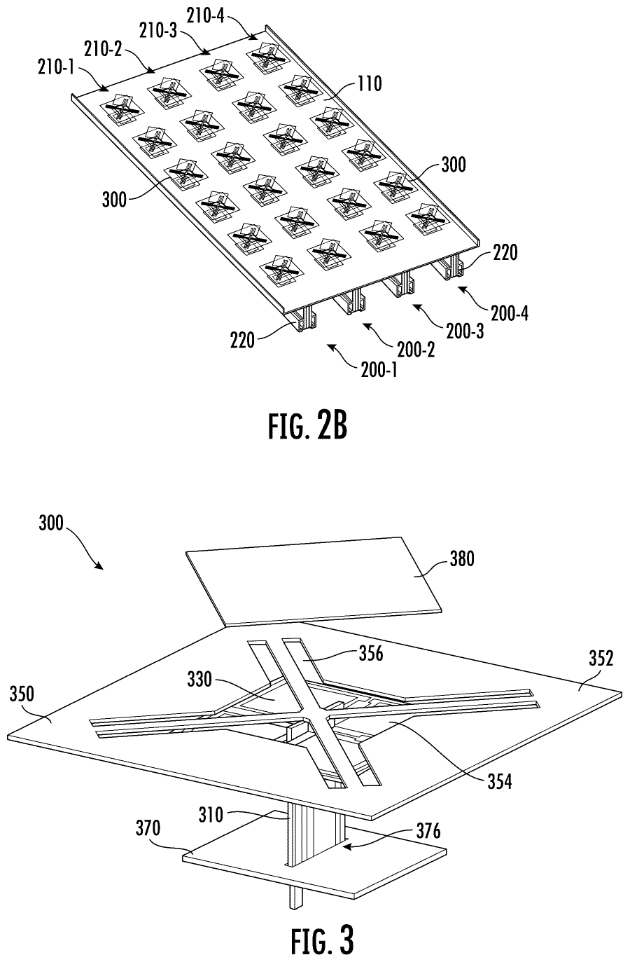

Embodiments of the present invention will now be described in greater detail with reference to FIGS. 2A-14F.

FIG. 2A is a schematic front view of a multiband base station antenna 100 according to embodiments of the present invention with the radome removed. The multiband base station antenna 100 is similar to base station antenna 1 in many respects. Accordingly, the discussion below will focus on the differences between base station antenna 1 and base station antenna 100. Elements that are the same in the two base station antennas 1, 100 are labeled using the same reference numerals.

As can be seen by comparing FIGS. 1B and 2A, the primary difference between the two base station antennas 1, 100 is that the four mid-band linear arrays 30-3 through 30-6 of base station antenna 100 and their associated feed networks (which are not visible in FIGS. 1A-1B) are replaced in base station antenna 100 with four mid-band linear array assemblies 200-1 through 200-4. The reflector 10 of base station antenna 1 is also replaced in base station antenna 100 with a modified reflector 110. It should also be noted that the mid-band feed board printed circuit boards 34 of base station antenna 1, each of which includes two mid-band radiating elements 32 thereon, are omitted in base station antenna 100. As will be discussed in more below, the feed board printed circuit boards 32 of base station antenna 1 are replaced in base station antenna 100 with base board printed circuit boards 370 that are part of the mid-band radiating elements 300.

FIG. 2B is a schematic front perspective view of the four mid-band linear array assemblies 200-1 through 200-4 that are included in base station antenna 100. FIG. 2B also shows the reflector 110 of the base station antenna 100 for context. As shown in FIG. 2A, the reflector 110 may extend substantially the entire length of the base station antenna 100, which provides increased structural strength. As shown in FIG. 2B, each mid-band linear array assembly 200 includes a mid-band linear array 210 of mid-band radiating elements 300 and a cavity phase shifter assembly 220. The cavity phase shifter assemblies 220 form the feed networks for the respective mid-band linear arrays 210. The reflector 110 includes a plurality of openings 112. Each mid-band radiating element 300 extends through a respective one of the openings 112 in the reflector 110 so that most of each mid-band radiating element 300 is positioned forwardly of the reflector 110, but a small portion of each mid-band radiating element 300 extends rearwardly of the reflector 110. The cavity phase shifter assemblies 220 are mounted rearwardly of the reflector 110. Each mid-band radiating element 300 may be configured to operate in the 1695-2690 MHz frequency band, or a portion thereof. To simplify the drawing, each of the first through fourth mid-band linear arrays 210-1 through 210-4 is shown in FIG. 2B as including a total of six mid-band radiating elements 300 that are arranged in respective vertically-extending columns. It will be appreciated that typically each mid-band linear array will include a larger number of mid-band radiating elements 300. For example, FIG. 2A shows each mid-band linear array 210 as having thirteen radiating elements, which is more typical. The number of mid-band radiating elements 300 included in each mid-band linear array 210 may be selected, for example, based on a desired elevation beamwidth for the antenna beams generated by the mid-band linear arrays 210.

Each mid-band cavity phase shifter assembly 220 is connected to a pair of the RF ports (not shown, but see RF ports 8 of FIG. 1A) since the mid-band radiating elements 300 are dual-polarized radiating elements that transmit and receive RF signals at two orthogonal polarizations. Each mid-band cavity phase shifter assembly 220 includes a plurality of output RF transmission lines that may be directly connected to the mid-band radiating elements 300, as will be described in more detail below.

FIG. 3 is a schematic side perspective view of one of the mid-band radiating elements 300 included in the mid-band linear array assemblies 200 of FIGS. 2A-2B. Referring first to FIG. 3, the mid-band radiating element 300 includes a single feed stalk printed circuit board 310, a small coupling printed circuit board 330, a metal radiator 350, a base board printed circuit board 370 and a director 380. The base board printed circuit board 370 includes a dielectric substrate 372 having a metallization pattern 374 (see FIG. 5) on a rear side thereof. A rectangular slot 376 is formed through the dielectric substrate 372 and the metal pattern 374. A base 312 of the feed stalk printed circuit board 310 is inserted through the slot 376. The slot 376 may be sized to provide an interference fit with the feed stalk printed circuit board 310. As will be explained below, the base board printed circuit board 370 may mechanically support the feed stalk printed circuit board 310 and may be used to couple ground signals to the feed stalk printed circuit board 310. Since the signal traces of the output RF transmission lines that feed the metal radiator 350 do not extend through the base board printed circuit board 370, the dielectric substrate 372 may comprise a low cost material such as FR4.

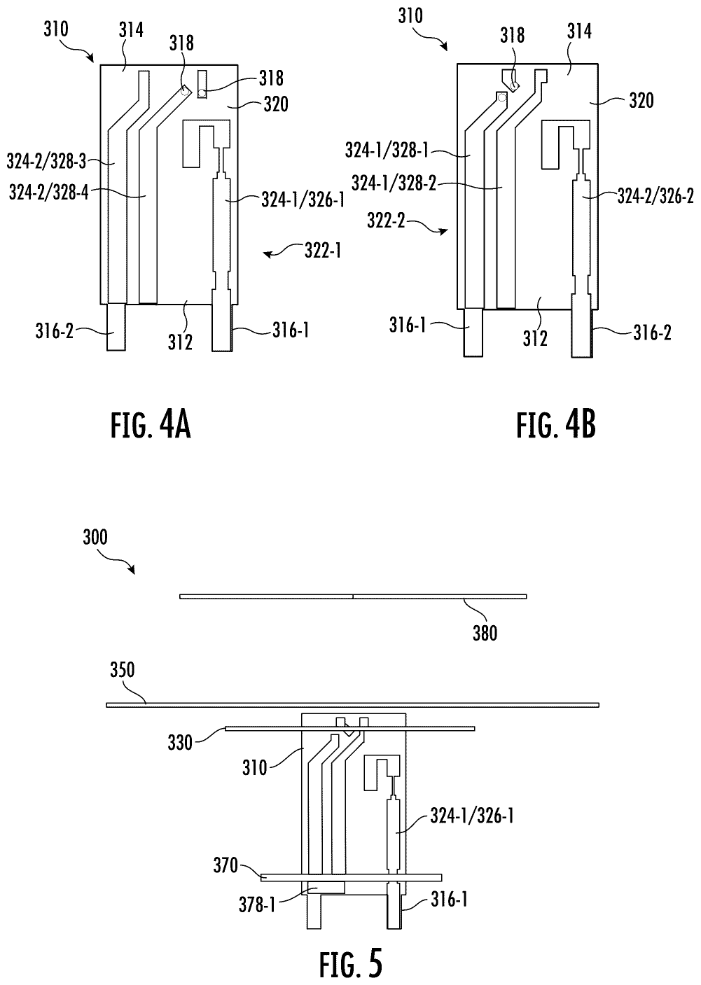

FIGS. 4A and 4B are plan views of the first and second major surfaces of the feed stalk printed circuit board 310 that is included in the mid-band radiating element of FIG. 3. FIG. 5 is a schematic side view of the mid-band radiating element 200 of FIG. 3. As shown in FIGS. 4A-4B, the feed stalk printed circuit board 310 has a base 312 and a distal (forward) end 314 that is positioned forwardly of the base 312. The feed stalk printed circuit board 310 comprises a dielectric substrate 320 that has a first metallization layer 322-1 (FIG. 4A) on one major surface of the dielectric substrate 320 and a second metallization layer 322-2 (FIG. 4B) on the other major surface of the dielectric substrate 320. The dielectric substrate 320 includes first and second rearwardly-extending tabs 316-1, 316-2, the purpose of which will be discussed below.

As shown in FIG. 4A, the first metallization layer 322-1 comprises a first signal trace 326-1 and third and fourth ground lines 328-3, 328-4. As shown in FIG. 4B, the second metallization pattern 322-2 comprises a second signal trace 326-2 and first and second ground lines 328-2, 328-1. The first signal trace 326-1 overlaps the first and second ground lines 328-1, 328-2 to form a first RF transmission line 324-1, and the second signal trace 326-2 overlaps the third and fourth ground lines 328-3, 328-4 to form a second RF transmission line 324-2. The first and second signal traces 326-1, 326-2 are each in the form of a hook balun. Feed stalks for radiating elements that employ hook balun-based RF transmission lines are well known in the art and hence description of the operation of RF transmission lines 324-1, 324-2 will be omitted here.

A pair of plated through holes 318 are provided through the dielectric substrate 320 that are used to allow the distal ends of the ground traces 328-1 and 328-4 to cross to the other side of the dielectric substrate 320 so that the ground traces 328 may be electrically connected to the correct ones of a plurality of metal pads 340 (discussed below) that are provided on the coupling printed circuit board 330.

The first signal trace 326-1 extends onto the first rearwardly extending tab 316-1 to facilitate electrically connecting the first signal trace 326-1 to an output RF transmission line of a first cavity phase shifter as will be discussed in greater detail with reference to FIG. 10. The first signal trace 326-1 extends forwardly from the first rearwardly extending tab 316-1 to about two-thirds of the way toward the distal end 314 of the feed stalk printed circuit board 310. The first signal trace 326-1 includes a long forwardly extending segment, a short transversely extending segment, and a short rearwardly extending segment. The forwardly extending segment includes a small narrow trace section that improves impedance matching. The transversely extending segment comprises a narrowed trace that extends from the end of the forwardly extending segment to cross over the gap between the first and second ground traces 328-1, 328-2, which are part of the second metallization pattern 322-2 on the opposed side of the dielectric substrate 320. The rearwardly extending segment extends at a right angle from the end of the transversely extending segment toward the base 312 of feed stalk printed circuit board 310.

The second signal trace 326-2 extends onto the second rearwardly extending tab 316-2 to facilitate electrically connecting the second signal trace 326-2 to an output RF transmission line of a second cavity phase shifter as will be discussed in greater detail with reference to FIG. 10. The second signal trace 326-2 has the same general design as the first signal trace 326-1 except that the second signal trace 326-2 overlaps the third and fourth ground traces 328-3, 328-4.

Each of the first through fourth ground traces 328-1 through 328-4 may have a length of about 0.1 to 0.3 of a wavelength that corresponds to the center frequency of the operating frequency band of radiating element 300.

Referring to FIGS. 3-5 and 10, the coupling printed circuit board 330 is mounted on the distal end 314 of the feed stalk printed circuit board 310. The coupling printed circuit board 330 includes a dielectric substrate 332 and a metallization pattern 334 formed on the front side of the dielectric substrate 332. A rectangular slot 336 extends through the dielectric substrate 332 and the metallization pattern 334. The distal end 314 of the feed stalk printed circuit board 310 extends through the rectangular slot 336 in the coupling printed circuit board 330 to mechanically mount the coupling printed circuit board 330 on the feed stalk printed circuit board 310. The metallization pattern 334 includes four metal pads 340-1 through 340-4 that are arranged in the respective four quadrants of a square defined by the dielectric substrate 332. The first and third metal pads 340-1, 340-3 are galvanically connected to the first and second ground traces 328-1, 328-2 of the first RF transmission line 324-1 on the feed stalk printed circuit board 310, and the second and fourth metal pads 340-2, 340-4 are galvanically connected to third and fourth ground traces 328-3, 328-4 of the second RF transmission line 324-2 that is formed the feed stalk printed circuit board 310.

As can also be seen from FIG. 10, the metallization pattern 334 further includes a metal ring 338 that surrounds the four metal pads 340. In addition, metal lines extend inwardly from the metal ring 338 in between adjacent ones of the metal pads 340. The metal ring 338 and metal lines 339 together act as a feed that may, for example, excite the metal radiator 350 with equivalent parallel capacitance. The metal lines 339 may improve impedance matching and/or the isolation between the orthogonal polarizations. The metal ring 338 can be replaced with a filled rectangle in other embodiments.

As is also shown in FIGS. 3 and 5, the metal radiator 350 is mounted forwardly of the coupling printed circuit board 330. The metal radiator 350 comprises a MONOLITHIC metal plate 352 that has a continuous metal perimeter. The metal plate 352 may comprise, for example, a sheet metal plate. A plurality of openings 354, 356 are included within the interior of the metal plate 352. The openings include a plurality of triangular openings 354 and a plurality of slot-like openings 356 that extend from outer corners of the triangular openings 354. The openings 354, 356 may be viewed as a discontinuous central opening 358 that has first and second metal strips 360-1, 360-2 extending therethrough that divide the central opening 358 into the four distinct openings, where each opening comprises a triangular opening 354 with a pair of slot-like openings 356 extending from the outer corners thereof. The first metal strip 360-1 may extend perpendicularly to the second metal strip 360-2. Four of the eight slot-like openings 356 may extend in parallel to the first metal strip 360-1 and the other four slot-like openings 356 may extend in parallel to the second metal strip 360-2. Each slot-like opening 356 and each metal strip 360 may extend at an angle of either −45° or +45° when the base station antenna 100 is mounted for use. The sheet metal plate 352 is configured to form a first −45° radiator and a second +45° radiator. Each radiator may be viewed as a dipole radiator, although the radiators may have aspects of both electronic dipoles and magnetic dipoles. The sheet metal plate 352 is capacitively coupled to the metal pads 340 on the coupling printed circuit board 330 so that RF signals can be passed between the feed stalk printed circuit board 310 and the metal radiator 350 through the coupling printed circuit board 330, as will be discussed in further detail below. One or more solder masks or other thin dielectric elements (not shown) may be positioned between the small coupling printed circuit board 330 and the metal radiator 350.

The director 380 is mounted forwardly of the metal radiator 350. The director 380 is configured to narrow the beamwidth of the antenna beams generated by the mid-band linear arrays 210 in at least a portion of the mid-band operating frequency range. The director 380 may be of conventional design.

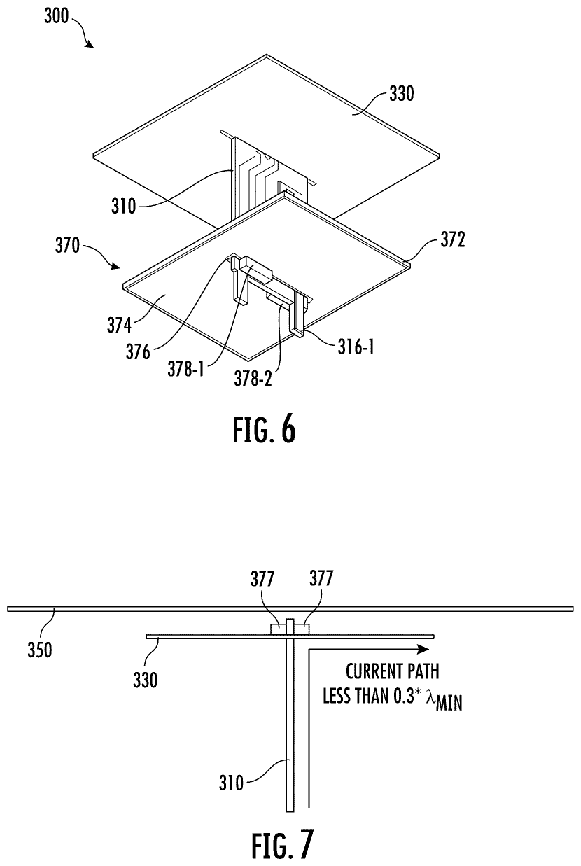

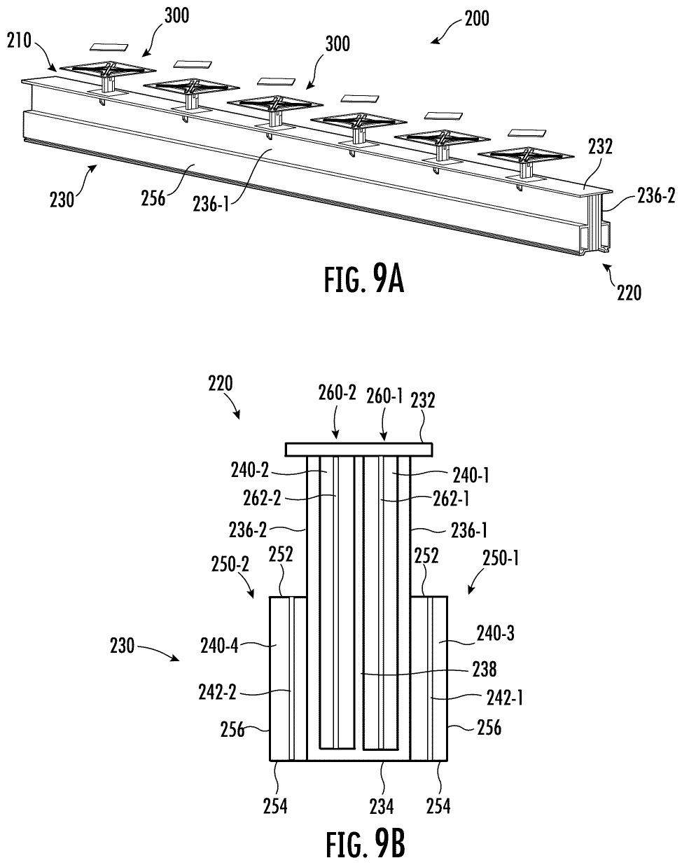

FIG. 6 is a schematic rear perspective view of the mid-band radiating element 300 of FIG. 3 that illustrates the mechanical and electrical connections between the base board printed circuit board 370 and the feed stalk printed circuit board 310. As shown in FIG. 6, the base 312 of the feed stalk printed circuit board 310 is received through the slot 376 in the base board printed circuit board 370. The rearwardly extending tabs 316-1, 316-2 at the base 312 of the feed stalk printed circuit board 310 extend even further rearwardly so that they may be received within first and second inner cavities of a cavity phase shifter assembly, as will be discussed in greater detail below with reference to FIGS. 9-10. As discussed above, the first signal trace 326-1 extends onto the first tab 316-1 and the second signal trace 326-2 extends onto the second tab 316-2. As shown in FIGS. 5 and 6, a first solder joint 378-1 is applied that galvanically connects the third and fourth ground traces 328-1, 328-2 to the metallization pattern 374 on the base board printed circuit board 370, and a second solder joint 378-2 is applied that galvanically connects the first and second ground traces 328-3, 328-4 to the metallization pattern 374.

As discussed above, various problems may arise when radiating elements that operate in different frequency bands are positioned in close proximity to each other in a base station antenna. One known problem is that a higher frequency radiating element may have a so-called “common mode resonance” that can distort the antenna beam of a nearby lower-band radiating element. Dipole-based radiating elements are differentially fed devices. However, the combination of the feed stalk and the dipole arm may resonate as a quarter wavelength monopole radiator. In other words, if RF radiation impinges on the mid-band radiating element 300 at a frequency that has a corresponding wavelength that is about four times the electrical length of the combination of the feed stalk and a dipole arm, then common mode currents may form on the feed stalk and the dipole radiator. These common mode currents will also cause radiation of RF energy. Typically, both the feed stalk and the dipole arms of a dipole-based radiating element have a length that is about one-quarter a wavelength (called the “center wavelength” herein) corresponding the center frequency of the operating frequency band of the radiating element. Thus, the combined length of the feed stalk and the dipole arm is about one-half the center wavelength. Since much of the mid-band operating frequency range includes frequencies that are twice the frequency of frequencies within the low-band operating frequency range, the combined length of the feed stalk and the dipole arm of a typical mid-band radiating element will be a little less than one quarter of the center wavelength of the low-band operating frequency range. As a result, common mode currents may flow on the mid-band radiating elements in response to RF energy that is transmitted by nearby low-band radiating elements. As these common mode currents emit RF radiation, the net effect is that the mid-band radiating elements may distort the antenna beams of nearby low-band radiating elements, degrading the performance of the low-band arrays. For example, the low-band radiation patterns may have reduced directivity and higher beamwidths than desired.

A known technique for suppressing the formation of such common mode currents on a mid-band radiating element is to integrate one or more inductor-capacitor (“LC”) circuits (often parallel LC circuits) along the current path between the feed stalk and the dipole arms of the mid-band radiating element. Most typically, a pair of parallel LC circuits (one for each polarization) are implemented on the feed stalk. These parallel LC circuits may be used to move common mode resonances that otherwise may be induced by the mid-band radiating element in response to RF energy emitted by nearby low-band radiating elements so that the resonance is outside the operating frequency range of the nearby low-band radiating elements. U.S. Pat. No. 11,688,945 and 12,021,315 disclose radiating elements that employ this technique to tune the common mode resonance to be outside the low-band operating frequency range.

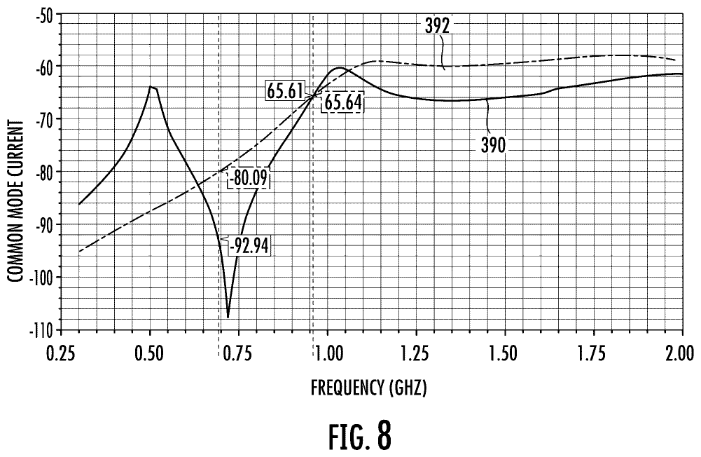

The mid-band radiating elements according to embodiments of the present invention, such as mid-band radiating element 300, take a different approach to suppress common mode resonances. This can be seen with reference to FIGS. 7 and 8.

FIG. 7 is a schematic side view of mid-band radiating element 300 with the director 380 omitted. The arrow in FIG. 7 shows a potential common mode current path. As discussed above, the length of the feed stalk printed circuit board 310 is about 0.1 to 0.3 of the wavelength of the mid-band operating frequency band.

As discussed above, the mid-band radiating element 300 is designed so that the coupling printed circuit board 330 is galvanically coupled to the feed stalk printed circuit board 310 and capacitively coupled to the metal radiator 350. The amount of capacitive coupling between the coupling printed circuit board 330 and the metal radiator 350 may be selected so that common mode currents in the low-band operating frequency band will be rejected and will not flow across the gap separating the coupling printed circuit board 330 from the metal radiator 350, while RF currents in the mid-band operating frequency range will flow across the gap (i.e. a good impedance match will be obtained between the metal radiator 350 and the coupling printed circuit board 330). In addition, the metal pads 340 on the coupling printed circuit board 330 may have a length that is significantly less than one quarter of the center wavelength of the mid-band operating frequency range, such as about one-tenth of the center wavelength. As a result, the electrical length of the combination of the metal pad 340 and the feed stalk printed circuit board 310 may be less than about 0.3*λₘᵢₙ, where λₘᵢₙ is the wavelength corresponding to the minimum frequency in the operating frequency band of the mid-band radiating element 300. This is shown schematically in FIG. 7. Since the length 0.3*λₘᵢₙ is much less than one quarter of a wavelength of any frequency in the low-band operating frequency range, common mode currents will largely not be induced on the mid-band radiating element 230 in response to RF energy emitted by nearby low-band radiating elements.

FIG. 8 is a graph illustrating the amplitude of the common mode currents generated on two different mid-band radiating elements in response to RF energy emitted by an adjacent low-band radiating element as a function of frequency. In FIG. 8, curve 390 shows the amplitude of the common mode currents for a conventional mid-band radiating element that employs the parallel LC circuit common mode resonance suppression technique that is discussed above and curve 392 for shows the amplitude of the common mode currents for the radiating element 300. As shown in FIG. 8, with the conventional technique, the parallel LC circuit creates a null in the common mode current response, and the location of this null is selected so that the common mode currents are below −65 dB throughout the low-band operating frequency range. The technique employed in the mid-band radiating elements according to embodiments of the present invention does not generate a null, but instead just limits the length of the common mode current path sufficiently so that the common mode currents are below −65 dB throughout the low-band operating frequency range.

As discussed above, each mid-band radiating element 300 is mounted on a cavity phase shifter assembly 220 to form a mid-band linear array assembly 200. FIGS. 9A-12 illustrate how the mid-band radiating elements 300 are mounted on and electrically connected to the cavity phase shifter assembly 220 and how the mid-band linear array assembly 200 is incorporated into the base station antenna 100.

FIGS. 9A-11 illustrate the cavity phase shifter assembly 220 in greater detail. In particular, FIG. 9A is a schematic front perspective view of one of the mid-band linear array assemblies 200 of FIG. 2. FIG. 9B is a schematic end view of the cavity phase shifter assembly 220 of the mid-band linear array assembly 200 of FIG. 9A. FIG. 10 is an exploded side perspective view illustrating how the mid-band radiating element 300 is mounted on the cavity phase shifter assembly 220. Finally, FIG. 11 is the same view as FIG. 10 with the metal shell 230 of the cavity phase shifter assembly 220 and the base board printed circuit board 370 of the mid-band radiating element 300 omitted to show how the feed stalk printed circuit board 310 of the mid-band radiating element 300 is mounted on a pair of phase shifter printed circuit boards 262-1, 262-2 of the cavity phase shifter assembly 220.

Referring to FIGS. 9A-9B, the mid-band linear array 200 assembly includes the mid-band linear array 210 and the cavity phase shifter assembly 220. The cavity phase shifter assembly 220 includes a longitudinally-extending metal shell 230. The metal shell 230 may be formed, for example, by extrusion. First and second longitudinally-extending cavities 240-1, 240-2 are defined within the metal shell 230. The metal shell 230 includes a front wall 232, a rear wall 234 and a pair of main sidewalls 236-1, 236-2 that together define the first and second cavities 240-1, 240-2. As shown, the first and second cavities 240-1, 240-2 may share a common sidewall 238 in some cases. The metal shell 230 further includes a first generally c-shaped structure 250-1 that extends laterally from the first main sidewall 236-1 and a second generally c-shaped structure 250-2 that extends laterally from the second main sidewall 236-2. Each generally c-shaped structure 250 may have a front wall 252 that extends parallel to the front wall 232, a rear wall 254 that extends parallel to (and possible coplanar with) the rear wall 234, and a sidewall 256 that extends parallel to the main sidewalls 236. The first generally c-shaped structure 250-1 and the first main sidewall 236-1 define a third cavity 240-3 and the second generally c-shaped structure 250-2 and the second main sidewall 236-2 define a fourth cavity 240-4. A longitudinal axis of each cavity 240 extend parallel to a longitudinal axis of the base station antenna 100.

A first phase shifter assembly 260-1 is mounted in the first cavity 240-1, and a second phase shifter assembly 260-2 is mounted in the second cavity 240-2. Each phase shifter assembly 260 may comprise, for example, a phase shifter printed circuit board 262 with RF transmission lines formed thereon. Each phase shifter printed circuit board 262 may include an input RF transmission line (not shown) such as a metal pad or trace that is electrically connected to a feed network of the base station antenna 100, a power divider (not shown) that splits RF signals input through the input RF transmission line into a plurality of sub-components, and a plurality of output RF transmission lines (not shown) where the phase adjusted sub-components of the RF signal are output. Each phase shifter assembly 260 may also include a phase shifter (not shown), such as a sliding dielectric phase shifter, that is configured to impart an adjustable phase taper to the sub-components of the RF signal before they reach the respective output RF transmission lines. First and second RF feed lines 242-1, 242-2 (e.g., stripline RF feed lines) may be disposed in the third and fourth cavities 240-3, 240-4. The first and second RF feed lines 242-1, 242-2 may be electrically connected to the respective input RF transmission lines on the first and second phase shifter printed circuit boards 262-1, 262-2.

Cavity phase shifter assemblies are known in the art. For example, U.S. Pat. No. 11,677,141 discloses a variety of cavity phase shifter assemblies and discusses the operation thereof. The entire content of U.S. Pat. No. 11,677,141 is incorporated herein by reference. Cavity phase shifter assemblies are typically used as they include low-loss stripline RF transmission lines and because they can be designed to provide cableless connections to the radiating elements, which reduces the number of solder joints. While FIGS. 9A-9B illustrates one cavity phase shifter design, it will be appreciated that any suitable cavity phase shifter assembly design may be used to implement the cavity phase shifter assemblies 310, including any of the cavity phase shifter assemblies disclosed in U.S. Pat. No. 11,677,141.

FIG. 10 is an exploded side perspective view illustrating how the mid-band radiating element 300 is mounted on the cavity phase shifter assembly 220. As shown in FIG. 10, the front wall 232 of the metal shell 230 has first and second small slots 233-1, 233-2 that are provided at the location where each mid-band radiating element 230 is to be mounted. The rearwardly-extending tabs 316-1, 316-2 on the feed stalk printed circuit board 310 are inserted through the respective first and second slots 233-1, 233-2 so that the base board printed circuit board 370 is on the front wall 232 of the metal shell 230. A solder mask (not shown) may be provided on the front wall 232 or on the metal pattern 374 on the base board printed circuit board 370 so that the metal shell 230 is capacitively coupled to the metal pattern 374 through the solder mask (or other dielectric layer). Windows 317 (only one window is visible in FIG. 10) are provided in the sidewalls 236-1, 236-2 of the metal shell 230 that allow solder joints 379 (FIG. 11) to be applied within the respective cavities 240-1, 240-2. The solder joints 379 electrically connect the portions of the signal traces 236-1, 236-2 that extend onto the tabs 316-1, 316-2 to the output RF transmission lines on the respective phase shifter circuit boards 262 that are mounted in the respective cavities 240-1, 240-2.

FIG. 11 is the same view as FIG. 10 with the metal shell 230 of the cavity phase shifter assembly 220 and a base board printed circuit board 370 of the mid-band radiating element 300 omitted to show how the feed stalk printed circuit board 310 is mounted on the first and second phase shifter printed circuit boards 262-1, 262-2 of the cavity phase shifter assembly 220.

As shown in FIG. 11, the first and second phase shifter printed circuit boards 262-1, 262-2 extend in parallel to each other in their respective cavities 240-1, 240-2 (not shown in FIG. 11). The first tab 316-1 on the feed stalk printed circuit board 310 may extend adjacent to an outer side of the first phase shifter printed circuit board 262-1 and the second tab 316-2 on the feed stalk printed circuit board 310 may extend adjacent to an outer side of the second phase shifter printed circuit board 262-2. The first tab 316-1 may extend on (or next to) a first output RF transmission line 264-1 on the first phase shifter printed circuit board 262-1 and a first solder joint 379-1 may be applied that physically and electrically connects the signal trace 326-1 on the first tab 316-1 to the first output RF transmission line 264-1 on the first phase shifter printed circuit board 262-1. The second tab 316-2 may extend on (or next to) a second output RF transmission line 264-2 on the second phase shifter printed circuit board 262-2 and a second solder joint (not visible in the figures) may be applied that physically and electrically connects the second signal trace 326-2 on the second tab 316-2 to the second output RF transmission line 264-2 on the second phase shifter printed circuit board 262-2.

As can also be seen from FIG. 11, the feedboard printed circuit board 310 of each mid-band radiating element intersects the phase shifter printed circuit boards 262 at an angle of 90°. This is mechanically more robust than solutions where the intersection is not at a 90° angle, and also may provide for improved solder joints.

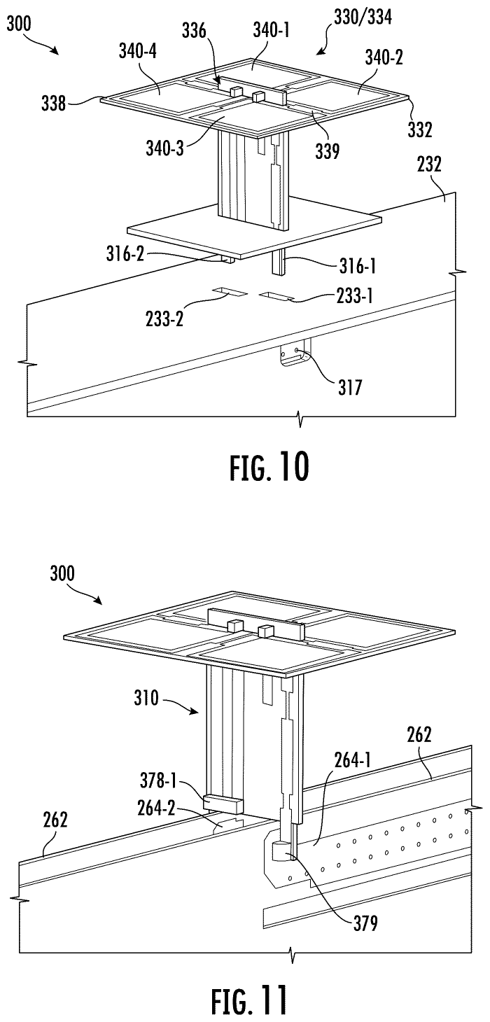

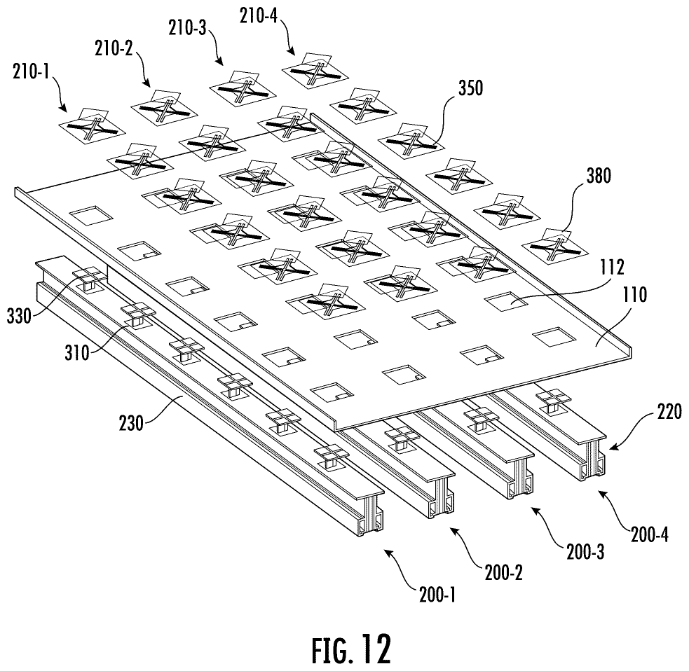

FIG. 12 is a schematic exploded from perspective view of the four mid-band linear array assemblies 200-1 through 200-4 of FIG. 2 that illustrates how the mid-band linear array assemblies 200 may be assembled through the reflector 110 of base station antenna 100. As shown in FIG. 12, the reflector 110 includes a plurality of openings 112 that are positioned at the locations where the mid-band radiating elements 300 are to be mounted. The openings 112 are larger than the footprint of the coupling printed circuit boards 330 so that the coupling printed circuit boards 330 can be inserted through the openings 112. The base 312 of feed stalk printed circuit board 310 of each mid-band radiating element 300 is mounted in the rectangular slot 376 in the base board printed circuit board 370, and the coupling printed circuit board 330 of each mid-band radiating element 300 is mounted on the distal end 314 of the feed stalk printed circuit board 310. Solder joints 377 (FIG. 7) are applied that physically and electrically connect the ground traces 328 on the feed stalk printed circuit board 310 to the metal pads 340 on the coupling printed circuit board 330 to provide a plurality of partially assembled mid-band radiating elements 300. Each partially assembled mid-band radiating elements 300 is then inserted into a respective one of the openings 112 in the reflector 110 so that the pair of rearwardly-extending tabs 316 of each radiating element 300 extend through a respective one of the pairs of slots 233 in the front walls 232 of the metal shells 230. The solder joints 378, 379 are then applied to electrically connect the RF transmission lines 324 on the feed stalk printed circuit board 310 to the output RF transmission lines 264 on the phase shifter printed circuit boards 262. The metal radiators 350 and directors 380 are then mounted on each mid-band radiating element 300 to complete the assembly of each mid-band radiating element 300. While not shown in the figures, each mid-band radiating element 300 may include a plastic support that holds the metal radiator 350 and director 380 thereof and which mounts the metal radiator 350 and director 380 to extend forwardly from the coupling printed circuit board 330.

Since the metal radiator 350 and director 380 of each mid-band radiating element 300 may be readily mounted on their associated coupling printed circuit boards 330 by simply snapping a plastic support in place, the metal radiator 350 and director 380 of each mid-band radiating element 300 may be installed onto each partially assembled mid-band radiating element 300 after the partially assembled mid-band radiating elements 300 have been installed into the cavity phase shifter assemblies 220 so that each cavity phase shifter assembly 220 may be fully assembled before it is installed into the base station antenna 100. Consequently, each cavity phase shifter assembly 220 may be fully tested before it is installed in the base station antenna 100 to identify poor solder joints, misconnections, defective components and the like. This allows problems to be identified and corrected before the base station antenna is assembled, and makes it much easier to fix any problems that are identified. After testing is completed, the metal radiator 350 and director 380 of each mid-band radiating element 300 may be removed so that the cavity phase shifter assembly 220 with the partially assembled mid-band radiating elements 300 thereon may be installed into the base station antenna 100. Then, the metal radiator 350 and director 380 of each mid-band radiating element 300 may again be attached.

As discussed above, the metal radiator 350 of each mid-band radiating element 300 includes a plurality of openings 354, 356. These openings 354, 356 reduce the amount of coupling between the metal pads 340 on the coupling printed circuit board 330 and the metal radiator 350. As discussed above, the amount of capacitive coupling between the metal pads 340 and the metal radiator 350 may be set so that common mode currents within the low-band operating frequency range are kept below a desired level.

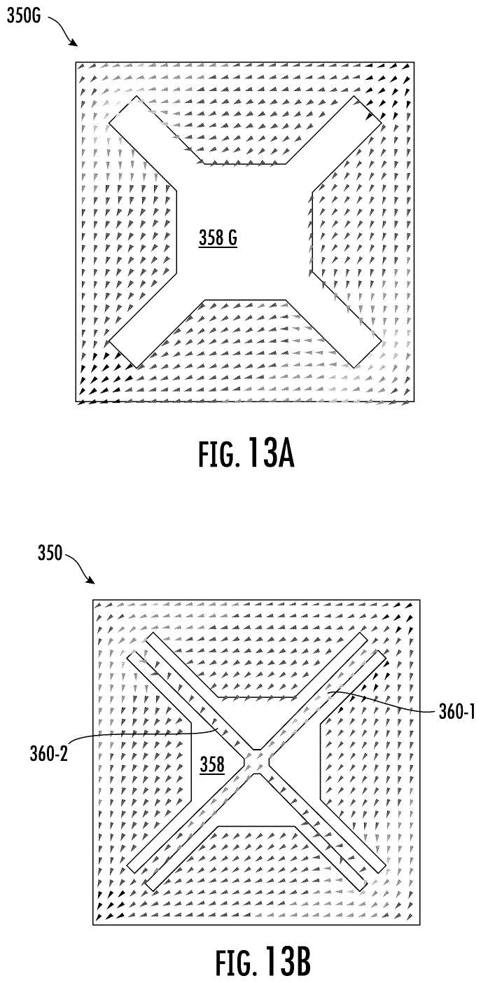

As shown in FIG. 13A, in some embodiments, a metal radiator 350G may be provided that includes a continuous opening 358G. However, as shown by the arrows in FIG. 13A, when an RF signal (here a +45° polarization RF signal) is fed to the metal radiator 350G, a total of two current paths are provided, namely a current path around each side of the opening 358G. As shown in FIG. 13B, in other embodiments of the present invention, the mid-band radiating elements 300 may include metal radiators 350 that include first and second metal strips 360-1, 360-2 that extend through the large opening 358 to divide the large opening 358 into the plurality of smaller openings 354, 356, as is discussed above. The first and second metal strips 360-1, 360-2 extend through the large opening 358. Current also travels along the metal strip 360 of the excited polarization providing a third current path. The provision of this third current path improves the impedance match between the radiators and the RF transmission line 324 on the feed stalk printed circuit board 310. For example, the metal radiator design shown in FIG. 13B keeps the return loss below −15 dB across the full 1.427-2.690 GHz mid-band operating frequency range.

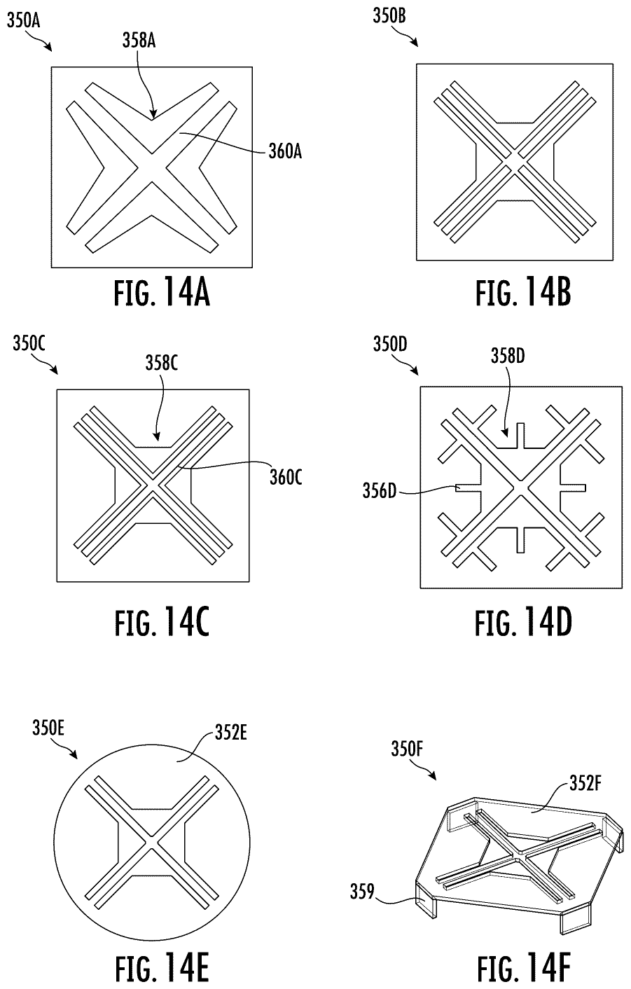

FIGS. 14A-14F are plan views of additional metal radiators 350A-350F, respectively, that may be used to implement the mid-band radiating elements according to embodiments of the present invention.

As shown in FIG. 14A, the metal radiator 350A is similar to metal radiator 350, but the metal strips 360A of metal radiator 350A are thicker than the metal strips 360 of metal radiator 350, and the central opening 358A has a somewhat different shape.

As shown in FIG. 14B, the metal radiator 350B is similar to metal radiator 350, but includes four metal strips 360B instead of two metal strips, and the four metal strips 360B merge into a small square of metal in the middle of the central opening 358B.

As shown in FIG. 14C, the metal radiator 350C is similar to metal radiator 350B, but small square of metal in the middle of the central opening 358B of metal radiator 350B is omitted in metal radiator 350C and the metal strips 360C do not extend the full length of the opening 358C so that metal radiator 350C may be viewed as having eight radially-extending metal strips 360C.

As shown in FIG. 14D, the metal radiator 350D is similar to metal radiator 350, but further includes four additional rectangular openings 356D that extend from the four sides of the central opening 358D.

As shown in FIG. 14E, the metal radiator 350E is similar to metal radiator 350, but includes a circular metal plate 352E as opposed to a square metal plate 352 as with metal radiator 350.

As shown in FIG. 14F, the metal radiator 350F is similar to metal radiator 350, but includes a rectangular metal plate 352F that has extensions 359 at the corners thereof that are bent downwardly. This allows the electrical length of the radiators to be increased without increasing the footprint of the metal plate 352F. It will be appreciated that any of the metal radiators according to embodiments of the present invention may include the extensions 359 and that the extensions may be bent upwardly or downwardly, and at any appropriate angle.

Referring again to FIGS. 3-7 and 9A-11, pursuant to some embodiments of the present invention, radiating elements 300 for a base station antenna 100 are provided that comprise a feed stalk printed circuit board 310, a coupling printed circuit board 330 mounted on a distal end 314 of the feed stalk printed circuit board 310, the coupling printed circuit board 330 including a plurality of metal pads 340, and a metal radiator 350 that is capacitively coupled to the coupling printed circuit board 330 and that forms at least part of a first radiator and a second radiator, the metal radiator 350 comprising a monolithic metal plate 352 that includes at least one opening 354, 356.

The at least one opening comprises a first slot-like opening 356 that has a first longitudinal axis that extends in a first direction and a second slot-like opening 356 that has a second longitudinal axis that extends in a second direction that is perpendicular to the first direction. The metal radiator 350 further includes a plurality of triangular-shaped openings 354. The first slot-like opening 356 extends from a first corner of a first of the triangular-shaped openings 354 and the second slot-like opening 356 extends from a second corner of the first of the triangular-shaped openings 354.

The metal radiator 350 includes an outer perimeter and the at least one opening comprises a first plurality of openings 354 that together form a discontinuous central opening 358 that is surrounded by the outer perimeter, and a plurality of slot-like openings 356 extend outwardly from the central opening 358. The metal radiator 350 further includes a first metal strip 360-1 that extends through the central opening 358 and a second metal strip 360-2 that extends through the central opening 358, where the second metal strip 360-2 intersects the first metal strip 360-1. A first of the slot-like openings 356 extends in parallel to the first metal strip 360-1 and a second of the slot-like openings 356 extends in parallel to the second metal strip 360-2.

An amount of capacitive coupling between the coupling printed circuit board 330 and the metal radiator 350 is selected so that common mode currents that are within the 696-960 MHz frequency range are substantially blocked from coupling from the coupling printed circuit board 330 to the metal radiator 350.

The feed stalk printed circuit board 310 is electrically coupled to both the first radiator and the second radiator. The metal radiator 350 may comprise a sheet metal radiator plate 352. The metal radiator 350 may include a planar main section and optionally may include a plurality of distal extensions 359 that are bent with respect to the planar main section (see FIG. 14F).

The radiating element 300 may also include a base board printed circuit board 370 that includes a slot 376 therethrough, and a base 312 of the feed stalk printed circuit board 310 may be inserted through the slot 376 in the base board printed circuit board 370. A rear side of the base board printed circuit board 370 may include a metal pad 374, and a plurality of ground traces 328 on the feed stalk printed circuit board 310 may be soldered to the metal pad 374.

In some embodiments, the radiating element 300 may be provided in combination with a cavity phase shifter assembly 220 that comprises a metal shell 230 having first and second cavities 240-1, 240-2, a first phase shifter 260-1 within the first cavity 240-1, and a second phase shifter 260-2 within the second cavity 240-2. The metal pad 374 on the base board printed circuit board 370 may, for example, be mounted to capacitively couple with the metal shell 230. The first phase shifter 260-1 may comprise a first phase shifter printed circuit board 262-1 and the second phase shifter 260-2 may comprise a second phase shifter printed circuit board 262-2, and the feed stalk printed circuit board 310 may be mounted on the first and second phase shifter printed circuit boards 262-1, 262-2. The feed stalk printed circuit board 310 may be mounted perpendicular to the first and second phase shifter printed circuit boards 262-1, 262-2. A first solder joint 379 may electrically connect a first signal trace 264 on the first phase shifter printed circuit board 262-1 to a first signal trace 326-1 on the feed stalk printed circuit board 310, and a second solder joint 379 may electrically connect a second signal trace 264 on the second phase shifter printed circuit board 262-2 to a second signal trace 326-2 on the feed stalk printed circuit board 310.

A front wall 232 of the metal shell 230 may include first and second openings 233-1, 233-2, and first and second rearwardly extending tabs 316-1, 316-2 on the feed stalk printed circuit board 310 may extend through the respective first and second openings 233-1, 233-2. A side wall 236 of the metal shell 230 may include a window 317 that is aligned with the first opening 233-1 in the front wall 232 of the metal shell 230.

The radiating element 300 and the cavity phase shifter assembly 220 may be part of a base station antenna 100, where the base station antenna 100 includes a reflector 110 that has an opening 112 that is larger than a footprint of the coupling printed circuit board 330, and where the radiating element 300 is mounted to extend through the opening 112 in the reflector 110. The first and second phase shifter printed circuit boards 262-1, 262-2 may be mounted rearwardly of the reflector 110. A footprint of the metal radiator 350 may be larger than the footprint of the opening 112 in the reflector 110.

Still referring to FIGS. 3-7 and 9A-11, pursuant to further embodiments of the present invention, a radiating element 300 for a base station antenna 100 is provide that comprises a base board printed circuit board 370 that comprises a dielectric substrate 372 and a metal pattern 374 on a first surface of the dielectric substrate 372, the base board printed circuit board 370 including a slot 376 that extends through the dielectric substrate 372 and the metal pattern 374, a feed stalk printed circuit board 310 that has a base 312 that is inserted through the slot 376 in the base board printed circuit board 370 and a distal end 314, a coupling printed circuit board 330 mounted on the distal end 314 of the feed stalk printed circuit board 310, and a metal radiator 350 that is capacitively coupled to the coupling printed circuit board 330. The feed stalk printed circuit 310 includes first and second pairs of ground traces 328 that are galvanically connected to the metal pattern 374 on the base board printed circuit board 370, and first and second signal traces 326 that are electrically isolated from the base board printed circuit board 370.

Pursuant to still further embodiments of the present invention, base station antennas 100 are provided that comprise a reflector 110, a first array 20-1 of lower frequency band radiating elements 22, and a second array 210-1 of higher frequency band radiating elements 300. At least some of the higher frequency band radiating elements 300 comprise a feed stalk 310, a coupling printed circuit board 330 mounted on the feed stalk 310, and a metal radiator 350 that is capacitively coupled to the coupling printed circuit board 330. An amount of capacitive coupling between the coupling printed circuit board 330 and the metal radiator 350 is selected so that common mode currents that are within an operating frequency range of the lower frequency band radiating elements 22 are substantially blocked from coupling from the coupling printed circuit board 330 to the metal radiator 350.

The reflector 110 includes a plurality of openings 112 and the at least some of the higher frequency band radiating elements 300 extend through the respective openings 112 in the reflector 110. Each of the plurality of openings 112 may be larger than footprints of the coupling printed circuit boards 330. The metal radiator 350 may comprise a monolithic metal plate 352 that has an outer perimeter and a plurality of openings 354, 356 that are surrounded by the outer perimeter. In some embodiments, the metal radiator 350 may further include a first metal strip 360-1 that extends through the plurality of openings 354. 356 and a second metal strip 360-2 that extends through the plurality of openings 354, 356, where the second metal strip 360-2 intersects the first metal strip 360-1.

The mid-band linear array assemblies according to embodiments of the present invention may have advantages over conventional mid-band linear arrays. First, since the mid-band linear array assemblies 200 are modular components, they can be almost completely assembled before they are installed in the base station antenna 100. This simplifies the manufacturing process. Second, since the metal radiators 350 and directors 380 of the mid-band radiating elements 300 may be removably attached to the remainder of the mid-band linear array assembly 200 before the mid-band linear array assembly 200 is installed in the base station antenna 100, the entire assembly 200 may be pre-tested before it is installed in the antenna 100. Third, since the mid-band linear array assembly 200 is modular in nature if problems are identified later during antenna level testing, the mid-band linear array assembly 200 can readily be removed from the base station antenna 100 without removing various other components, making it much easier to fix problems (e.g., poor solder joints) detected during antenna level testing. Fourth, since the mid-band radiating elements 300 include a single feed board printed circuit board 310 that is positioned perpendicularly to the column direction of the high-band beamforming array 40, the mid-band radiating elements 300 included in the mid-band linear array assembly 200 may have reduced impact on the patterns of any adjacent high-band beamforming array 40. Fifth, since the mid-band radiating elements 300 include common mode rejection circuits, they may have reduced impact on nearby low-band radiating elements 22.

The present invention has been described above with reference to the accompanying drawings. The present invention is not limited to the illustrated embodiments. Rather, these embodiments are intended to fully and completely disclose the present invention to those skilled in this art. In the drawings, like numbers refer to like elements throughout. Thicknesses and dimensions of some components may be exaggerated for clarity.

Spatially relative terms, such as “under,” “below,” “lower,” “over,” “upper,” “top,” “bottom,” and the like, may be used herein for case of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the example term “under” can encompass both an orientation of over and under. The device may be otherwise oriented (rotated 90 degrees or at other orientations) and the spatially relative descriptors used herein interpreted accordingly.

Herein, the terms “attached,” “connected,” “interconnected,” “contacting,” “mounted,” “coupled,” and the like can mean either direct or indirect attachment or coupling between elements, unless stated otherwise.

Well-known functions or constructions may not be described in detail for brevity and/or clarity. As used herein the expression “and/or” includes any and all combinations of one or more of the associated listed items.

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “comprises,” “comprising,” “includes,” and/or “including” when used in this specification, specify the presence of stated features, operations, elements, and/or components, but do not preclude the presence or addition of one or more other features, operations, elements, components, and/or groups thereof.

1. A radiating element, comprising:
a feed stalk printed circuit board;
a coupling printed circuit board mounted on a distal end of the feed stalk printed circuit board, the coupling printed circuit board including a plurality of metal pads; and
a metal radiator that is capacitively coupled to the coupling printed circuit board and that forms at least part of a first radiator and a second radiator, the metal radiator comprising a monolithic metal plate that includes at least one opening.

2-4. (canceled)

5. The radiating element of claim 1, wherein the metal radiator includes an outer perimeter and the at least one opening comprises a first plurality of openings that together form a discontinuous central opening that is surrounded by the outer perimeter, and a plurality of slot-like openings extend outwardly from the central opening.

6. The radiating element of claim 5, wherein the metal radiator further includes a first metal strip that extends through the central opening and a second metal strip that extends through the central opening, where the second metal strip intersects the first metal strip.

7. The radiating element of claim 6, wherein a first of the slot-like openings extends in parallel to the first metal strip and a second of the slot-like openings extends in parallel to the second metal strip.

8. The radiating element of claim 1, wherein an amount of capacitive coupling between the coupling printed circuit board and the metal radiator is selected so that common mode currents that are within the 696-960 MHz frequency range are substantially blocked from coupling from the coupling printed circuit board to the metal radiator.

9. The radiating element of claim 1, wherein the feed stalk printed circuit board is electrically coupled to both the first radiator and the second radiator.

10. The radiating element of claim 1, wherein the metal radiator comprises a sheet metal radiator plate.

11. The radiating element of claim 10, wherein the metal radiator includes a planar main section and a plurality of distal extensions that are bent with respect to the planar main section.

12. The radiating element of claim 1, further comprising a base board printed circuit board that includes a slot therethrough, wherein the base of the feed stalk printed circuit board is inserted through the slot in the base board printed circuit board.

13-22. (canceled)

23. A radiating element, comprising:
a base board printed circuit board that comprises a dielectric substrate and a metal pattern on a first surface of the dielectric substrate, the base board printed circuit board including a slot that extends through the dielectric substrate and the metal pattern;
a feed stalk printed circuit board that has a base that is inserted through the slot in the base board printed circuit board and a distal end;
a coupling printed circuit board mounted on the distal end of the feed stalk printed circuit board; and
a metal radiator that is capacitively coupled to the coupling printed circuit board,
wherein the feed stalk printed circuit includes first and second pairs of ground traces that are galvanically connected to the metal pattern on the base board printed circuit board, and first and second signal traces that are electrically isolated from the base board printed circuit board.

24. The radiating element of claim 23, wherein the metal radiator forms at least part of a first radiator and a second radiator, the metal radiator comprising a monolithic metal plate that includes at least one opening.

25. The radiating element of claim 24, wherein the at least one opening comprises a first slot-like opening that has a first longitudinal axis that extends in a first direction and a second slot-like opening that has a second longitudinal axis that extends in a second direction that is perpendicular to the first direction.

26. The radiating element of claim 25, wherein the metal radiator further includes a plurality of triangular-shaped openings.

27. The radiating element of claim 26, wherein the first slot-like opening extends from a first corner of a first of the triangular-shaped openings and the second slot-like opening extends from a second corner of the first of the triangular-shaped openings.

28. The radiating element of claim 24, wherein the metal radiator includes an outer perimeter and the at least one opening comprises a first plurality of openings that together form a discontinuous central opening that is surrounded by the outer perimeter, and a plurality of slot-like openings extend outwardly from the central opening.

29. The radiating element of claim 28, wherein the metal radiator further includes a first metal strip that extends through the central opening and a second metal strip that extends through the central opening, where the second metal strip intersects the first metal strip.

30-33. (canceled)

34. The radiating element of claim 23 in combination with a cavity phase shifter assembly that comprises:
a metal shell having first and second cavities;
a first phase shifter within the first cavity; and
a second phase shifter within the second cavity,
wherein the metal pad on the base board printed circuit board is mounted to capacitively couple with the metal shell.

35. The radiating element of claim 34, wherein the first phase shifter comprises a first phase shifter printed circuit board and the second phase shifter comprises a second phase shifter printed circuit board, and wherein the feed stalk printed circuit board is mounted on the first and second phase shifter printed circuit boards.

36. The radiating element of claim 35, wherein a first solder joint electrically connects a first signal trace on the first phase shifter printed circuit board to a first signal trace on the feed stalk printed circuit board, and a second solder joint electrically connects a second signal trace on the second phase shifter printed circuit board to a second signal trace on the feed stalk printed circuit board.

37. The radiating element of claim 34, wherein a front wall of the metal shell includes first and second openings, and first and second rearwardly extending tabs on the feed stalk printed circuit board extend through the respective first and second openings.

38-42. (canceled)
